(19) United States
(12) Patent Application Publication
(10) Pub. No.: US 2026/0056827 A1
(43) Pub. Date: Feb. 26, 2026

(54) MEMORY LEAK DETECTION METHOD AND APPARATUS, ELECTRONIC DEVICE, AND A STORAGE MEDIUM

(71) Applicant: Beijing Zitiao Network Technology Co., Ltd., Haidian District (CN)

(72) Inventor: Wenwen HUANG, Beijing (CN)

(21) Appl. No.: 19/306,174

(22) Filed: Aug. 21, 2025

(30) Foreign Application Priority Data
Aug. 22, 2024 (CN) 202411161903.8

(51) Int. Cl. G06F 11/07; G06F 8/61

(52) U.S. Cl. CPC G06F 11/079; G06F 8/61; G06F 11/073

(57) ABSTRACT

Embodiments of the present disclosure provide a memory leak detection method and apparatus, an electronic device, and a storage medium. The method includes: obtaining a memory leak detection instruction for a first application, and generating a running instruction for the first application based on the memory leak detection instruction randomly; triggering the first application to run based on the running instruction, and obtaining running data of the first application; obtaining a memory snapshot of the first application in response to the running data of the first application meeting a running data requirement; and performing memory leak detection on a plurality of first specified classes of the first application based on the memory snapshot of the first application. The first specified classes include service-related classes in the first application.

### CROSS-REFERENCE TO RELATED APPLICATION(S)

This application claims priority to Chinese Application No. 202411161903.8 filed on Aug. 22, 2024, the disclosure of which is incorporated herein by reference in its entirety.

### FIELD

The present disclosure relates to the field of computer technologies, and in particular, to a memory leak detection method and apparatus, an electronic device, and a storage medium.

### BACKGROUND

In the field of computers, a memory leak means that a memory that is no longer in use in a program is not reclaimed due to a program error or another cause. The memory leak can cause a memory waste. As the program runs, the memory leak may possibly lead to serious consequences such as slowing down or even crashing the program.

In the prior art, for an application, a main method for detecting a memory leak includes: integrating a memory leak detection tool package into the application, and manually triggering a page of the application to run the application. In response to a memory leak occurring during running of the application, the above tool package can prompt a code part in which the memory leak occurs.

However, in the above solution, the application needs to run by manual triggering, so that the labor participation is high, and the memory leak detection efficiency is low. Moreover, the tool package can only detect whether a memory leak occurs for a small number of classes. This further reduces the memory leak detection efficiency.

### SUMMARY

Embodiments of the present disclosure provide a memory leak detection method and apparatus, an electronic device, and a storage medium.

In a first aspect, an embodiment of the present disclosure provides a memory leak detection method, including:
obtaining a memory leak detection instruction for a first application, and generating a running instruction for the first application based on the memory leak detection instruction randomly;
triggering the first application to run based on the running instruction, and obtaining running data of the first application;
obtaining a memory snapshot of the first application in response to the running data of the first application meeting a running data requirement;
performing memory leak detection on a plurality of first specified classes of the first application based on the memory snapshot of the first application. The first specified classes include service-related classes in the first application.

In a second aspect, an embodiment of the present disclosure provides a memory leak detection apparatus, including:
an instruction generation unit configured to obtain a memory leak detection instruction for a first application, and generate a running instruction for the first application based on the memory leak detection instruction randomly;
a data obtaining unit configured to trigger the first application to run based on the running instruction, and obtain running data of the first application;
a snapshot obtaining unit configured to obtain a memory snapshot of the first application in response to the running data of the first application meeting a running data requirement; and
a leak detection unit configured to perform memory leak detection on a plurality of first specified classes of the first application based on the memory snapshot of the first application. The first specified classes include service-related classes in the first application.

In a third aspect, an embodiment of the present disclosure provides an electronic device. The electronic device includes: a processor; and a memory configured to store computer-executable instructions which, when executed, cause the processor to implement steps of the method as described in the first aspect.

In a fourth aspect, an embodiment of the present disclosure provides a computer-readable storage medium. The computer-readable storage medium is for storing computer-executable instructions which, when executed by a processor, implement steps of the method as described in the first aspect.

In a fifth aspect, an embodiment of the present disclosure provides a computer program product, where the computer program product includes computer programs which, when executed by a processor, implement steps of the method as described in the first aspect.

### BRIEF DESCRIPTION OF THE DRAWINGS

To describe the technical solutions in one or more embodiments of the present disclosure or in the prior art more clearly, the following briefly introduces the accompanying drawings for describing the embodiments or the prior art. Apparently, the accompanying drawings in the following description show merely some embodiments of the present disclosure, and a person of ordinary skill in the art may still derive other drawings from the accompanying drawings without creative efforts.

FIG. 1 is a schematic flowchart of a memory leak detection method according to an embodiment of the present disclosure;

FIG. 2 is a schematic flowchart of a memory leak detection method according to another embodiment of the present disclosure;

FIG. 3 is a schematic structural diagram of a memory leak detection apparatus according to an embodiment of the present disclosure; and

FIG. 4 is a schematic structural diagram of an electronic device according to an embodiment of the present disclosure.

### DETAILED DESCRIPTION OF EMBODIMENTS

To make a person skilled in the art to better understand the technical solutions of one or more embodiments of the present disclosure, the technical solutions in one or more embodiments of the present disclosure are described clearly and completely below with reference to the accompanying drawings in one or more embodiments of the present disclosure. Apparently, the described embodiments are merely some rather than all of the embodiments of the present disclosure. All other embodiments obtained by a person of ordinary skill in the art based on one or more embodiments of the present disclosure without creative efforts shall fall within the protection scope of the present disclosure.

It can be understood that before use of the technical solutions disclosed in various embodiments of the present disclosure, users should be informed of the type, scope of use, usage scenarios, and the like of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure based on the prompt information.

As an optional but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It can be understood that the above notification and the above user authorization obtaining process are only illustrative and do not constitute a limitation on the implementations of the present disclosure. Other methods that meet the relevant laws and regulations can also be applied to the implementations of the present disclosure.

Embodiments of the present disclosure provide a memory leak detection method, which can automatically perform memory leak detection on a plurality of specified classes of an application, to improve memory leak detection efficiency. For ease of understanding this embodiment, proper nouns involved in this embodiment will be explained herein.
Class: it is an object programming-oriented core concept. A class is an abstract description of a group of objects that have the same attributes and methods. It defines attributes that these objects will have and methods that can be performed on these attributes. Therefore, a class is like a template of an object.
Object: it is an object programming-oriented core concept. An object is an instantiation of a class or a specific instance of a class and has an attribute and method that are defined by the class.
Service class and universal class: applications can be used for providing various services. For example, a short video application can provide a shopping service, a short video browsing service, a short video uploading service, a live streaming service, and the like. In the embodiments of this specification, for ease of description, service-related classes in an application are referred to as service classes, and service-unrelated classes in the application are referred to as universal classes. A service-related class can be, for example, a class for implementing a service function of a service, such as for implementing a short video posting function. A service-unrelated class can be, for example, a class for implementing a function that is unrelated to a specific service, such as for obtaining input data of a user or outputting data to a user.
Memory leak: it means that a memory that is no longer in use in a program is not reclaimed due to a program error or another cause. During memory leak detection, it can be referred to as performing memory leak detection on classes in a program, or performing memory leak detection on objects in a program. The two description ways are not fundamentally different. The embodiments in this specifically use the former description way.

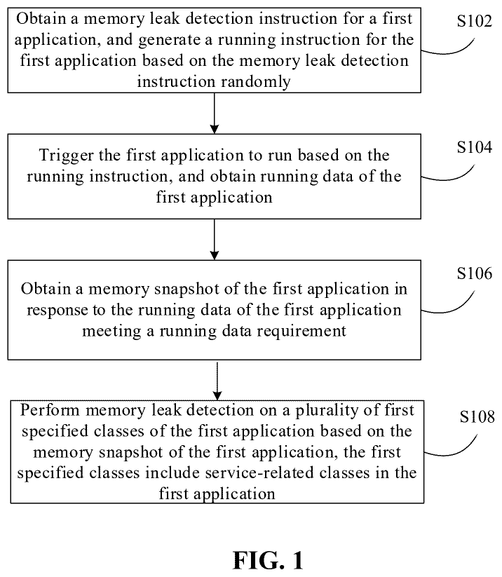

FIG. 1 is a schematic flowchart of a memory leak detection method according to an embodiment of the present disclosure. As shown in FIG. 1, the flow includes the following steps.

In step S102, a memory leak detection instruction for a first application is obtained, and a running instruction for the first application is generated based on the memory leak detection instruction randomly.

In step S104, the first application is triggered to run based on the running instruction, and running data of the first application is obtained.

In step S106, a memory snapshot of the first application is obtained in response to the running data of the first application meeting a running data requirement.

In step S108, memory leak detection is performed on a plurality of first specified classes of the first application based on the memory snapshot of the first application. The first specified classes include service-related classes in the first application.

In this embodiment, first, a memory leak detection instruction for a first application is obtained, and a running instruction for the first application is generated based on the memory leak detection instruction randomly. Then, the first application is triggered to run based on the running instruction, and running data of the first application is obtained. Next, in response to the running data of the first application meeting a running data requirement, a memory snapshot of the first application is obtained. Finally, memory leak detection is performed on a plurality of first specified classes of the first application based on the memory snapshot of the first application. The first specified classes include service-related classes in the first application. As can be seen, according to this embodiment, the running instruction for the first application can be generated randomly, and the first application can be triggered to run based on the running instruction, so that automatic running of the first application is implemented, and memory leak detection efficiency is improved. Furthermore, the memory leak detection is automatically performed on the plurality of first specified classes related to services based on the memory snapshot of the first application. Starting with the services provided by the first application, a quantity of classes for performing the memory leak detection is increased, which further improves the memory leak detection efficiency. Therefore, according to this embodiment, the memory leak detection can be automatically performed on a plurality of specified classes of an application, to improve the memory leak detection efficiency.

The memory leak detection methods in the embodiments of the present disclosure can be applied to a memory leak detection device and performed by the memory leak detection device. The memory leak detection device can be, for example, an electronic device such as a computer. The memory leak detection device can be communicatively connected to an application running device. The first application requiring memory leak detection is installed on the application running device. Through the communication between the memory leak detection device and the application running device, the memory leak detection can be performed on the first application by using the memory leak detection device. The first application can be any application. This embodiment does not impose a limitation.

In the above step S102, the memory leak detection instruction for the first application is obtained. A technician can input the memory leak detection instruction for the first application to a computer, so that the computer, as a memory leak detection device, can obtain the memory leak detection instruction for the first application.

In the above step S102, the memory leak detection device further generates the running instruction for the first application based on the memory leak detection instruction randomly. In this embodiment, based on the principle of a Monkey experiment, the running instruction for the first application may be generated randomly by simulating a mode for randomly operating an application through an instruction generation program. Therefore, it is likely that there is no service flow correlation between randomly generated running instructions which are a series of random running instructions.

In an embodiment, before generating the running instruction for the first application based on the memory leak detection instruction randomly, the method further includes:
obtaining a latest service code enabling rule of a first service based on the memory leak detection instruction, where the first service is a service provided by the first application and has a plurality of versions of service codes, and the latest service code enabling rule is a latest rule of the first service for selecting and enabling a version of service code from the plurality of versions of service codes; and
configuring the first service based on the latest service code enabling rule. The configured first service is ran based on the latest service code enabling rule.

In this embodiment, the first application provides various services. For example, the first application is a short video application that provides a shopping service, a short video browsing service, a short video uploading service, a live streaming service, and the like. In this embodiment, the first service is one or more services provided by the first application and having a plurality of versions of service codes.

In this embodiment, the memory leak detection device obtains a latest service code enabling rule of the first service based on the memory leak detection instruction. In a development process of the first service, as a user need changes, the first service may change a plurality of versions of service codes. Therefore, the first service has the plurality of versions of service codes. When the first application runs, the first service can only select and run a version of service code from the plurality of versions of service codes. Based on this, the latest service code enabling rule of the first service is a latest rule, relative to current time, that selects and enables a version of service code from the plurality of versions of service codes. The latest service code enabling rule of the first service may be determined through negotiation among developers of the first application.

Next, the memory leak detection device configures the first service based on the latest service code enabling rule. The configured first service runs based on the latest service code enabling rule. That is, when the first application runs, the first service can select and enable a version of service code from the plurality of versions of service codes based on the latest service code enabling rule. The memory leak detection device may send a configuration instruction to the application running device, and trigger the application running device to configure the first service based on the latest service code enabling rule.

In an example, there are two first services in the first application, namely first service A and first service B. First service A has an old version of service code and a new version of service code. First service B has an old version of service code and a new version of service code. In this embodiment, the memory leak detection device obtains a latest service code enabling rule of first service A and a latest service code enabling rule of first service B based on the memory leak detection instruction.

Next, the memory leak detection device sends the configuration instruction to the application running device based on the latest service code enabling rule of first service A and the latest service code enabling rule of first service B, and triggers the application running device to configure first service A and first service B respectively, to cause the configured first service A and configured first service B to run based on the latest service code enabling rules.

As can be seen, according to this embodiment, by obtaining the latest service code enabling rule of the first service and configuring the first service based on the latest service code enabling rule, the configured first service can be ran based on the latest service code enabling rule, so that in the process of performing the memory leak detection on the first application, the first service can run based on the latest service code enabling rule of the first service. A memory leak situation of the first application in a latest running mode can be detected, and accuracy of memory leak detection can be improved.

In an embodiment, before obtaining the latest service code enabling rule of the first service based on the memory leak detection instruction, the method further includes:
obtaining a memory leak detection installation package of the first application based on the memory leak detection instruction, where the memory leak detection installation package of the first application is obtained by configuring a memory snapshot export interface for a user side installation package of the first application, and the memory snapshot export interface is used for exporting the memory snapshot of the first application; and
installing the first application by using the memory leak detection installation package of the first application.

In this embodiment, the first application has a user side installation package and a developer side installation package. The user side installation package may be referred to as a release Android package (APK), and the developer side installation package may be referred to as a debug APK. Considering a development requirement, the developer side installation package may have more code content than the user side installation package, making it easier for a developer to develop the first application. When the first application is released, a user can obtain and install the user side installation package.

In this embodiment, the memory leak detection device obtains the user side installation package of the first application, configures a memory snapshot export interface for the user side installation package of the first application, obtains a memory leak detection installation package of the first application, and uses the memory leak detection installation package of the first application to install the first application. The first application may be installed on the above application running device. The memory snapshot export interface is located in the memory leak detection installation package of the first application, and may be called by the memory leak detection device to export the memory snapshot of the first application.

As can be seen, according to this embodiment, the memory leak detection installation package of the first application can be obtained based on the memory leak detection instruction, and the first application can be installed by using the memory leak detection installation package of the first application. Since the memory snapshot export interface is configured in the memory leak detection installation package of the first application, it is possible to export the memory snapshot of the first application by using the memory snapshot export interface during running of the first application, thereby improving the memory leak detection efficiency. Moreover, since the memory leak detection installation package of the first application is obtained by configuring the memory snapshot export interface for the user side installation package of the first application, compared with configuring the memory snapshot export interface for the developer side installation package of the first application, excessive redundant codes may not exist in the memory leak detection installation package of the first application, which can eliminate noise interference of some test codes and improve the memory leak detection accuracy. Moreover, the memory leak detection installation package is closer to the user side installation package used by the user, so that a memory leak detection environment is more in line with an environment in which the user uses the first application. This further improves the memory leak detection accuracy.

From the above description, it can be seen that in an embodiment, the memory leak detection device obtains the memory leak detection instruction for the first application, obtains the memory leak detection installation package of the first application based on the memory leak detection instruction, and uses the memory leak detection installation package of the first application to install the first application in the above application running device. Then, the memory leak detection device obtains the latest service code enabling rule of the first service in the first application based on the memory leak detection instruction, and configures the first service based on the latest service code enable rule. Next, step S102 is performed. The memory leak detection device generates the running instruction for the first application based on the memory leak detection instruction randomly. Then, step S104 is performed. The memory leak detection device triggers the first application to run based on the running instruction and obtains the running data of the first application.

In the above step S104, the memory leak detection device sends the above generated running instruction to the application running device, triggers the first application to run based on the running instruction, and obtains the running data of the first application in the running process of the first application. In this embodiment, since the running instruction for the first application is generated randomly, the first application is also in a random running state. Therefore, this embodiment can perform the memory leak detection on the first application while the first application runs randomly, thereby improving the memory leak detection comprehensiveness and accuracy.

Next, in the above step S106, the memory leak detection device obtains the memory snapshot of the first application in response to the running data of the first application meeting the running data requirement. Since the memory snapshot export interface is configured in the memory leak detection installation package of the first application, in an embodiment, the obtaining a memory snapshot of the first application includes:
sending a memory snapshot obtaining request to the first application through the memory snapshot export interface; and
obtaining, through the memory snapshot export interface, the memory snapshot returned by the first application based on the memory snapshot obtaining request.

In this embodiment, the first application runs on the application running device. The memory leak detection device is communicatively connected to the application running device. The memory snapshot obtaining request is sent to the first application through the memory snapshot export interface of the first application. After the first application receives the memory snapshot obtaining request, the memory snapshot of the first application is obtained, and the obtained memory snapshot is sent to the memory leak detection device through the memory snapshot export interface, so that the memory leak detection device obtains, through the memory snapshot export interface, the memory snapshot returned by the first application based on the memory snapshot obtaining request.

As can be seen, according to this embodiment, the memory snapshot obtaining request can be sent to the first application through the memory snapshot export interface, and the memory snapshot returned by the first application based on the memory snapshot obtaining request can be obtained through the memory snapshot export interface. With the help of the memory snapshot export interface, the memory snapshot of the first application can be efficiently and quickly obtained.

In an embodiment, in step S106, a memory snapshot of the first application being obtained in response to the running data of the first application meeting a running data requirement includes:
during running of the first application, obtaining the memory snapshot of the first application each time it is determined that the running data of the first application meets the running data requirement, until running duration of the first application reaches a first duration threshold.

In this embodiment, the memory leak detection device configures the running duration of the first application to be at least the first duration threshold during the performing of the memory leak detection on the first application. In the running process of the first application, the memory leak detection device continuously monitors whether the running data of the first application meets the running data requirement. The memory leak detection device obtains the memory snapshot of the first application each time it is determined that the running data of the first application meets the running data requirement, until the running duration of the first application reaches the first duration threshold.

As can be seen, according to this embodiment, during the performing of the memory leak detection on the first application, the running duration of the first application can be configured to be at least the first duration threshold, and the memory snapshot of the first application can be obtained for a plurality of times in the running process of the first application, thereby accurately analyzing a memory leak situation of the first application and improving analysis accuracy.

In this embodiment, the running data of the first application includes a size of a first memory occupied by the running of the first application and the running duration of the first application. The running data requirement includes the first memory being equal to or greater than the memory threshold or the running duration of the first application reaching a second duration threshold. Therefore, in this embodiment, when the first memory occupied by the running of the first application is equal to or greater than the memory threshold, the memory snapshot of the first application is obtained once; and when the running duration of the first application reaches the second duration threshold, the memory snapshot of the first application is obtained once.

In an embodiment, the obtaining the memory snapshot of the first application each time it is determined that the running data of the first application meets the running data requirement includes:
obtaining the memory snapshot of the first application each time it is determined that a first memory occupied by the running of the first application is equal to or greater than a memory threshold;
and
obtaining the memory snapshot of the first application at an interval of a second duration threshold.

In this embodiment, the memory leak detection device continuously monitors whether the first memory occupied by the running of the first application is equal to or greater than the memory threshold, and obtains the memory snapshot of the first application each time it is determined that the first memory occupied by the running of the first application is equal to or greater than the memory threshold. The memory leak detection device starts a timer, and obtains the memory snapshot of the first application at an interval of a second duration threshold no matter whether the first memory occupied by the running of the first application is equal to or greater than the memory threshold.

In this embodiment, as shown earlier, the memory leak detection device sends the memory snapshot obtaining request to the first application through the memory snapshot export interface, and the memory leak detection device obtains, through the memory snapshot export interface, the memory snapshot returned by the first application based on the memory snapshot obtaining request. The first application runs on the application running device.

As can be seen, according to this embodiment, the memory snapshot of the first application can be regularly obtained, and when the first memory occupied by the running of the first application is equal to or greater than the memory threshold, the memory snapshot of the first application is obtained, so as to accurately perform memory leak analysis by using the memory snapshot.

In an embodiment, before it is determined, for the first time, that the first memory occupied by the running of the first application is equal to or greater than the memory threshold, the method further includes:
obtaining a total memory allocated to the first application by an operating system of the first application; and
using a product result of the total memory and a first proportion as the memory threshold.

In this embodiment, the first application runs on the application running device. The total memory allocated to the first application by the operating system of the first application, i.e., an operating system of the application running device, is obtained. The product result of the total memory and a first proportion, such as 80%, is used as the memory threshold.

As can be seen, according to this embodiment, the total memory allocated to the first application by the operating system of the first application can be obtained, and the product result of the total memory and the first proportion can be used as the memory threshold, thus setting the memory threshold properly and improving accuracy of obtaining the memory snapshot.

After the memory snapshot of the first application is obtained in step S106, in the above step S108, the memory leak detection is performed on a plurality of first specified classes of the first application based on the memory snapshot of the first application. The first specified classes include service-related classes in the first application.

In this embodiment, the first application may provide various services, such as a short video posting service, a live streaming service, and a shopping service. The first specified classes include classes for implementing service functions in the first application, such as a class for implementing a shopping function. A quantity of the first specified classes is plural, and the first specified classes can also be referred to as service classes. In this embodiment, a list of classes requiring for performing the memory leak detection in the first application is configured in advance. The classes in this list are the first specified class. In addition to the service classes, the first specified classes may further include universal classes, such as Activity and Fragment commonly found in an Android system or an iOS system.

In this embodiment, the memory leak detection can be performed on the plurality of first specified classes of the first application based on the memory snapshot of the first application. Starting with the services provided by the first application, a quantity of classes for performing the memory leak detection is increased, which further improves the memory leak detection efficiency.

In an embodiment, the memory leak detection on the plurality of first specified classes of the first application being performed based on the memory snapshot of the first application includes:
for each first specified class of the first application, determining whether a memory leak occurs for the first specified class based on the memory snapshot of the first application; and
in response to a memory leak occurring for the first specified class, determining a memory leak cause of the first specified class based on the memory snapshot of the first application.

In this embodiment, the memory leak detection needs to be performed on the plurality of first specified classes of the first application. The memory leak detection includes two aspects: determining whether the memory leak occurs and determining a memory leak cause. For each first specified class, whether the memory leak occurs for the first specified class is determined based on the memory snapshot of the first application. In response to the memory leak occurring for the first specified class, a memory leak cause of the first specified class is determined based on the memory snapshot of the first application. In response to no memory leak occurring for the first specified class, the detection process on the first specified class ends.

As can be seen, according to this embodiment, for each first specified class of the first application, whether the memory leak occurs for the first specified class is determined based on the memory snapshot of the first application. In response to the memory leak occurring for the first specified class, the memory leak cause of the first specified class is determined based on the memory snapshot of the first application. In response to no memory leak occurring for the first specified class, the detection process on the first specified class ends. Thus, efficient and accurate memory leak detection is implemented for each first specified class.

In an embodiment, determining whether the memory leak occurs for the first specified class based on the memory snapshot of the first application includes:
obtaining memory release information and memory occupancy data of the first specified class from the memory snapshot; and
in response to the memory release information indicating that a memory occupied by the first specified class has been released and the memory occupancy data indicating that the memory occupied by the first specified class is greater than zero, determining that the memory leak occurs for the first specified class.

Any one first specified class is taken as an example. In this embodiment, the memory release information and memory occupancy data of the first specified class are first obtained from the memory snapshot. The memory release information may be a flag bit for indicating whether a memory of the first specified class has been released, and the memory occupancy data includes a size of a memory that is currently occupied by the first specified class. If the memory release information indicates that the memory occupied by the first specified class has been released, but the memory occupancy data indicates that the memory occupied by the first specified class is greater than zero, it indicates that the memory occupied by the first specified class should be released, but the release fails. It determines that a memory leak occurs for the first specified class.

On the contrary, if the memory release information indicates that the memory occupied by the first specified class has been released and the memory occupancy data indicates that the memory occupied by the first specified class is equal to zero, it indicates that the memory occupied by the first specified class is released and the release succeeds. It determines that no memory leak occurs for the first specified class.

As can be seen, according to this embodiment, the memory release information and memory occupancy data of the first specified class can be obtained from the memory snapshot, and whether a memory leak occurs for the first specified class can be accurately determined based on the memory release information and memory occupancy data of the first specified class.

In an embodiment, in response to a memory leak occurring for the first specified class, determining a memory leak cause of the first specified class based on the memory snapshot of the first application includes:
obtaining call link data of the first specified class from the memory snapshot, where the call link data records memory usage data of a related class which has a call relationship with the first specified class; and
determining the memory leak cause of the first specified class based on the call link data.

In this embodiment, after it is determined that the memory leak occurs for the first specified class, the call link data of the first specified class is obtained from the memory snapshot. The call link data records the memory usage data of the related class which has the call relationship with the first specified class. The related class may be a service class of the first application or a universal class of the first application. Next, the memory leak cause of the first specified class is determined based on the call link data and the memory usage data of the related class.

A memory leak occurring for a class is often caused by improper memory use of another class which has a call relationship with the class. Therefore, in this embodiment, the call link data of the first specified class is obtained from the memory snapshot, and the memory leak cause of the first specified class is accurately determined based on the call link data, to improve accuracy of determining the memory leak cause.

In an embodiment, determining the memory leak cause of the first specified class based on the call link data includes:
determining, based on the call link data and in the related class, a problem class causing the memory leak of the first specified class and problem memory usage data of the problem class; and
using the problem class and the problem memory usage data as the memory leak cause of the first specified class.

In an example, the call link data records that related class A calls related class B, related class B calls related class C, and related class C calls the first specified class. Based on this, in this embodiment, the problem class causing the memory leak of the first specified class and the problem memory usage data of the problem class are determined based on the call link data and in the related class. The obtained problem class is determined as related class B, and related class B has the problem memory usage data. Since related class B has the problem memory usage data, the memory leak of the first specified class is caused.

In this embodiment, the problem class and the problem memory usage data are used as the memory leak cause of the first specified class. For example, related class B and the problem memory usage data of related class B are used as the memory leak cause of the first specified class.

As can be seen, according to this embodiment, the problem class causing the memory leak of the first specified class and the problem memory usage data of the problem class are determined based on the call link data and in the related class. The problem class and the problem memory usage data are used as the memory leak cause of the first specified class. Thus, the memory leak cause of the first specified class is accurately determined.

In an embodiment, after determining the memory leak cause of the first specified class based on the memory snapshot of the first application, the method further includes:
obtaining a memory leak size of the first specified class from the memory snapshot of the first application; and
generating a memory leak detection report of the first application based on the memory leak cause of the first specified class and the memory leak size of the first specified class.

In this embodiment, the memory snapshot of the first application also records the memory leak size, such as 10 KB, of the first specified class. In this embodiment, the memory leak detection report of the first application is generated based on the memory leak cause of the first specified class and the memory leak size of the first specified class.

As mentioned earlier, the first application needs to run continuously for the first duration threshold, and the memory snapshot of the first application can be obtained for many times during running. Therefore, the memory leak cause of the first application, namely, the memory leak cause of the first specified class, may be determined for many times. Moreover, each memory leak cause may lead to a plurality of memory leaks, and each leak has its own memory leak size. Therefore, the memory leak detection report can record memory leak causes of the first specified class, a number of memory leaks caused by each memory leak cause, each memory leak size for each memory leak cause, and a total memory leak size for each memory leak cause. The memory leak detection report may further record the memory snapshots for determining the memory leak causes.

As can be seen, according to this embodiment, the memory leak size of the first specified class can be obtained from the memory snapshot of the first application. Based on the memory leak cause of the first specified class and the memory leak size of the first specified class, the memory leak detection report of the first application can be generated, which facilitates a developer to solve a memory leak problem of the first application based on the memory leak detection report.

As described above, the memory leak detection method in the embodiments of the present disclosure can be applied to the memory leak detection device and performed by the memory leak detection device. The memory leak detection device can be, for example, an electronic device such as a computer. The memory leak detection device can be communicatively connected to an application running device. The first application requiring memory leak detection is installed on the application running device. Through the communication between the memory leak detection device and the application running device, the memory leak detection can be performed on the first application by using the memory leak detection device. The first application can be any application. This embodiment does not impose a limitation.

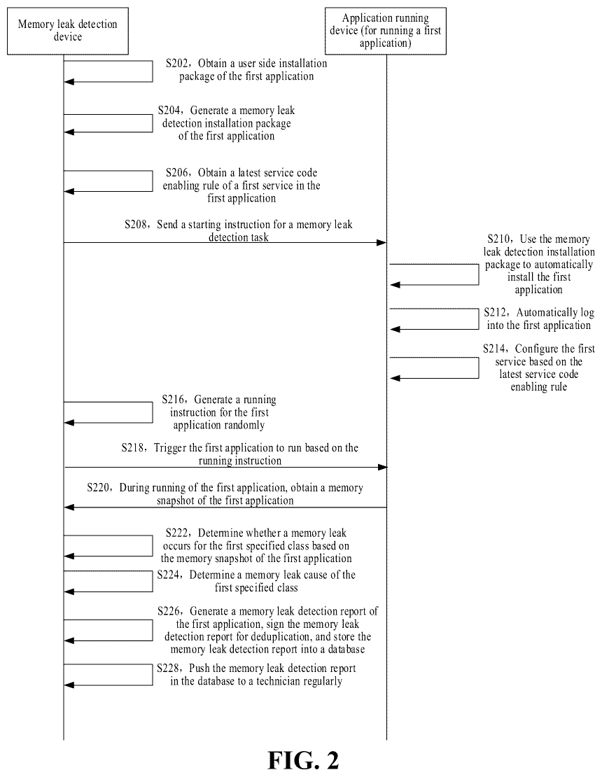

Based on this, FIG. 2 is a schematic flowchart of a memory leak detection method according to another embodiment of the present disclosure. As shown in FIG. 2, the flow includes the following steps.

In step S202, a memory leak detection device obtains a memory leak detection instruction for a first application, and obtains a user side installation package of the first application based on the memory leak detection instruction.

In step S204, the memory leak detection device configures a memory snapshot export interface in the user side installation package of the first application, and generates a memory leak detection installation package of the first application.

In step S206, the memory leak detection device obtains a latest service code enabling rule of a first service in the first application.

In step S208, the memory leak detection device sends a starting instruction for a memory leak detection task to an application running device. The instruction carries the memory leak detection installation package of the first application and the latest service code enabling rule of the first service.

In step S210, the application running device uses, based on the starting instruction, the memory leak detection installation package, to automatically install the first application.

In step S212, the application running device automatically logs into the first application.

In step S214, the application running device configures the first service based on the latest service code enabling rule.

In step S216, the memory leak detection device generates a running instruction for the first application randomly.

In step S218, the memory leak detection device triggers the first application to run based on the running instruction.

In step S220, in a running process of the first application, the memory leak detection device obtains a memory snapshot of the first application each time it is determined that a first memory occupied by the running of the first application is equal to or greater than a memory threshold, and obtains a memory snapshot of the first application at an interval of a second duration threshold. The first application continuously runs for a first duration threshold.

In step S222, for each first specified class of the first application, the memory leak detection device determines whether a memory leak occurs for the first specified class based on the memory snapshot of the first application.

In step S224, for the first specified class in which a memory leak occurs, the memory leak detection device analyzes the memory snapshot in conjunction with a mapping file, and determines a memory leak cause of the first specified class.

In this step, a code in the memory snapshot is restored through the mapping file to facilitate further analysis of the memory leak cause.

In step S226, the memory leak detection device generates a memory leak detection report of the first application, signs memory leak detection report for deduplication, and stores the memory leak detection report into a database.

In this step, the memory leak detection report includes the memory leak cause of the first specified class and a memory leak size of the first specified class, and may further include the memory snapshot for determining the memory leak cause of the first specified class. The memory leak cause, the memory leak size, and the corresponding memory snapshot are signed and deduplicated, and are then stored into the database.

In step S228, the memory leak detection device regularly pushes the memory leak detection report in the database to a technician for the technician to solve a memory leak problem.

In this embodiment, the memory leak situation of the first application can also be counted based on the memory leak detection report. For example, a rank of a first specified class in which a memory leak easily occurs, a rank of a memory leak cause, and the like can be counted.

In this embodiment:
1. the running instruction for the first application is generated randomly, to allow the application to cover as many pages as possible and discover more problems in advance;
2. the memory leak detection device is responsible for analyzing a memory snapshot, with high execution efficiency and no impact on the running of the first application;
3. the memory leak detection installation package is generated by using the user side installation package of the first application, the first application is installed, and redundant codes are not integrated into the user side installation package, to eliminate interference of some testing codes; and
4. custom class detection can be supported, to achieve detection of more classes.

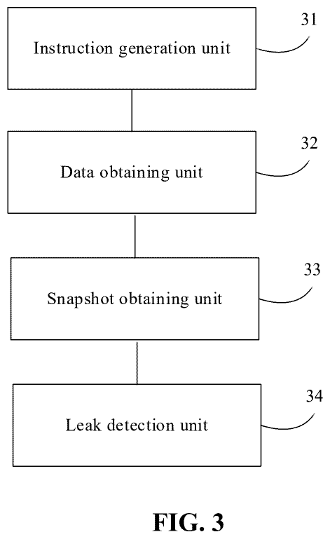

FIG. 3 is a schematic structural diagram of a memory leak detection apparatus according to an embodiment of the present disclosure. As shown in FIG. 3, the apparatus includes:
an instruction generation unit 31 configured to obtain a memory leak detection instruction for a first application, and generate a running instruction for the first application based on the memory leak detection instruction randomly;
a data obtaining unit 32 configured to trigger the first application to run based on the running instruction, and obtain running data of the first application;
a snapshot obtaining unit 33 configured to obtain a memory snapshot of the first application in response to the running data of the first application meeting a running data requirement; and
a leak detection unit 34 configured to perform memory leak detection on a plurality of first specified classes of the first application based on the memory snapshot of the first application. The first specified classes include service-related classes in the first application.

Optionally, the apparatus further includes a configuration unit configured to, before generating the running instruction for the first application based on the memory leak detection instruction randomly, obtain a latest service code enabling rule of a first service based on the memory leak detection instruction, where the first service is a service provided by the first application and has a plurality of versions of service codes, and the latest service code enabling rule is a latest rule of the first service for selecting and enabling a version of service code from the plurality of versions of service codes; and configure the first service based on the latest service code enabling rule. The configured first service is ran based on the latest service code enabling rule.

Optionally, the apparatus further includes an installation unit configured to, before obtaining the latest service code enabling rule of a first service based on the memory leak detection instruction, obtain a memory leak detection installation package of the first application based on the memory leak detection instruction, where the memory leak detection installation package of the first application is obtained by configuring a memory snapshot export interface for a user side installation package of the first application, and the memory snapshot export interface is used for exporting the memory snapshot of the first application; and install the first application by using the memory leak detection installation package of the first application.

Optionally, the snapshot obtaining unit 33 is specifically configured to send a memory snapshot obtaining request to the first application through the memory snapshot export interface; and obtain, through the memory snapshot export interface, the memory snapshot returned by the first application based on the memory snapshot obtaining request.

Optionally, the snapshot obtaining unit 33 is specifically configured to, during running of the first application, obtain the memory snapshot of the first application each time it is determined that the running data of the first application meets the running data requirement, until running duration of the first application reaches a first duration threshold.

Optionally, the snapshot obtaining unit 33 is specifically configured to obtain the memory snapshot of the first application each time it is determined that a first memory occupied by the running of the first application is equal to or greater than a memory threshold; and obtain the memory snapshot of the first application at an interval of a second duration threshold.

Optionally, the snapshot obtaining unit 33 is specifically configured to, before it is determined, for the first time, that the first memory occupied by the running of the first application is equal to or greater than the memory threshold, obtain a total memory allocated to the first application by an operating system of the first application; and use a product result of the total memory and a first proportion as the memory threshold.

Optionally, the leak detection unit 34 is specifically configured to, for each first specified class of the first application, determine whether a memory leak occurs for the first specified class based on the memory snapshot of the first application; and in response to the memory leak occurring for the first specified class, determine a memory leak cause of the first specified class based on the memory snapshot of the first application.

Optionally, the leak detection unit 34 is specifically configured to obtain memory release information and memory occupancy data of the first specified class from the memory snapshot; and in response to the memory release information indicating that a memory occupied by the first specified class has been released and the memory occupancy data indicating that the memory occupied by the first specified class is greater than zero, determine that a memory leak occurs for the first specified class.

Optionally, the leak detection unit 34 is specifically configured to obtain call link data of the first specified class from the memory snapshot, where the call link data records memory usage data of a related class which has a call relationship with the first specified class; and determine the memory leak cause of the first specified class based on the call link data.

Optionally, the leak detection unit 34 is specifically configured to determine, based on the call link data and in the related class, a problem class causing the memory leak of the first specified class and problem memory usage data of the problem class; and use the problem class and the problem memory usage data as the memory leak cause of the first specified class.

Optionally, the apparatus further includes a report generation unit configured to, after determining the memory leak cause of the first specified class based on the memory snapshot of the first application, obtain a memory leak size of the first specified class from the memory snapshot of the first application; and generate a memory leak detection report of the first application based on the memory leak cause of the first specified class and the memory leak size of the first specified class.

The memory leak detection apparatus in this embodiment of the present disclosure can implement the processes of the embodiments of the above memory leak detection method, and achieve the same effects and functions. Details will be omitted herein.

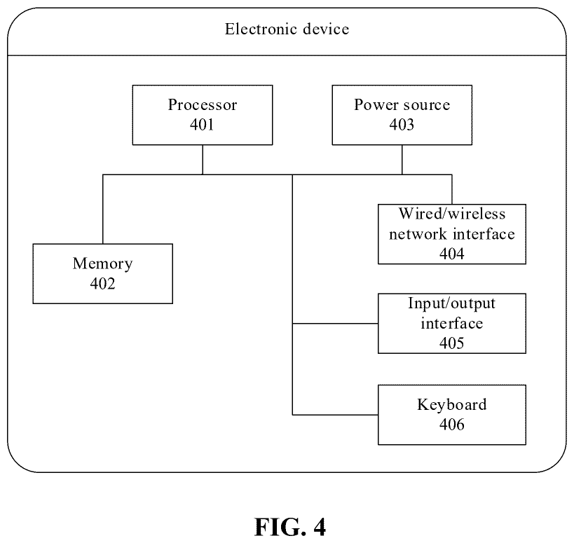

An embodiment of the present disclosure further provides an electronic device. FIG. 4 is a schematic structural diagram of an electronic device according to an embodiment of the present disclosure. As shown in FIG. 4, the electronic device has a significance difference because of different configurations or performance, and may include one or more processors 401 and a memory 402. One or more applications or data may be stored in the memory 402. The memory 402 may achieve short-term storage or persistent storage. The application stored in the memory 402 may include one or more above modules (not shown), and each module may include a series of computer-executable instructions in the electronic device. Still further, the processor 401 may be configured to communicate with the memory 402 to execute the series of computer-executable instructions in memory 402 on the electronic device. The electronic device may further include one or more power sources 403, one or more wired or wireless network interfaces 404, one or more input or output interfaces 405, one or more keyboards 406, and the like.

In a specific embodiment, the electronic device includes a processor; and a memory configured to store computer-executable instructions. The computer-executable instructions, when executed, cause the processor to implement the following flow:
obtaining a memory leak detection instruction for a first application, and generating a running instruction for the first application based on the memory leak detection instruction randomly;
triggering the first application to run based on the running instruction, and obtaining running data of the first application;
obtaining a memory snapshot of the first application in response to the running data of the first application meeting a running data requirement;
performing memory leak detection on a plurality of first specified classes of the first application based on the memory snapshot of the first application. The first specified classes include service-related classes in the first application.

The electronic device in this embodiment of the present disclosure can implement the processes of the embodiments of the above memory leak detection method, and achieve the same effects and functions. Details will be omitted herein.

Another embodiment of the present disclosure further provides a computer-readable storage medium for storing computer-executable instructions. The computer-executable instructions, when executed by a processor, implement the following flow:
obtaining a memory leak detection instruction for a first application, and generating a running instruction for the first application based on the memory leak detection instruction randomly;
triggering the first application to run based on the running instruction, and obtaining running data of the first application;
obtaining a memory snapshot of the first application in response to the running data of the first application meeting a running data requirement;
performing memory leak detection on a plurality of first specified classes of the first application based on the memory snapshot of the first application. The first specified classes include service-related classes in the first application.

The storage medium in this embodiment of the present disclosure can implement the processes of the embodiments of the above memory leak detection method, and achieve the same effects and functions. Details will be omitted herein.

Another embodiment of the present disclosure further provides a computer program product. The computer program product includes computer programs. The computer programs, when executed by a processor, implement the following flow:
obtaining a memory leak detection instruction for a first application, and generating a running instruction for the first application based on the memory leak detection instruction randomly;
triggering the first application to run based on the running instruction, and obtaining running data of the first application;
obtaining a memory snapshot of the first application in response to the running data of the first application meeting a running data requirement;
performing memory leak detection on a plurality of first specified classes of the first application based on the memory snapshot of the first application. The first specified classes include service-related classes in the first application.

The computer program product in this embodiment of the present disclosure can implement the processes of the embodiments of the above memory leak detection method, and achieve the same effects and functions. Details will be omitted herein.

In the embodiments of the present disclosure, the computer-readable storage medium includes a read-only memory (ROM), a random access memory (RAM), a magnetic disc, a compact disc, or the like.

In the 1990s, improvements on a technology can be clearly distinguished between hardware improvements (such as improvements on circuit structures such as a diode, a transistor, and a switch) and software improvements (improvements on method flows). However, with the development of technology, the improvements on many method flows today can be regarded as direct improvements on hardware circuit structures. Designers almost always obtain corresponding hardware circuit structures by programming improved method flows into hardware circuits. Therefore, it cannot be said that an improvement on a method flow cannot be achieved through hardware entity modules. For example, a programmable logic device (PLD) (such as a field programmable gate array (FPGA)) is such an integrated circuit, a logic function of which is determined by a user programming the device. Designers can program themselves “integrate” a digital system onto a PLD, without asking a chip manufacturer to design and manufacture a specialized integrated circuit chip. Moreover, nowadays, instead of manually producing an integrated circuit chip, this programming is mostly implemented by using “logic compiler” software which is similar to a software compiler used in program development and writing. To compile a previous original code, the previous original code is also written in a specific programming language, which is called a hardware description language (HDL). There are many HDL types, not only one, such as an advanced boolean expression language (ABEL), an altera hardware description language (AHDL), Confluence, a cornell university programming language (CUPL), HDCal, a Java hardware description language (JHDL), Lava, Lola, MyHDL, PALASM, and a Ruby hardware description language (RHDL). Very-high-speed integrated circuit hardware description language (VHDL) and Verilog are the most commonly used HDLs. Those skilled in the art should also be aware that it is easy to obtain a hardware circuit that implements the logical method flow by simply logically programing the method flow into an integrated circuit by using the above hardware description languages.

A controller may be implemented in any proper manner. For example, the controller may use a form of, for example, a microprocessor or processor, a computer-readable medium that stores computer-readable program codes (e.g., software or firmware) executable by the (micro) processor, a logic gate, a switch, an application specific integrated circuit (ASIC), a programmable logic controller, or an embedded microcontroller. Examples of the controller include, but are not limited to, the following micro controllers: ARC 625D, Atmel AT91SAM, Microchip PIC18F26K20, and Silicone Labs C8051F320. A memory controller may be further implemented as a part of a control logic of a memory. Those skilled in the art that also know that in addition to achieving the controller by pure computer-readable program codes, the controller can be entirely enabled, by logically programming the steps of the method, to achieve the same functions in the form of a logic gate, a switch, an ASIC, a programmable logic controller, an embedded microcontroller, and the like. Thus, this controller may be regarded as a hardware component, and apparatuses included in the controller and configured for implementing various functions may alternatively be regarded as structures in the hardware component. Or even, the apparatuses configured for implementing the various functions may be regarded as structures in both the software modules that implement the method and the hardware component.

Systems, apparatuses, modules, or units explained in the above embodiments may be specifically implemented by a computer chip or entity, or by a product having a function. A typical implementation device is a computer. Specifically, the computer may be, for example, a personal computer, a laptop, a cell phone, a camera phone, a smart phone, a personal digital assistant, a media player, a navigation device, an email device, a game console, a tablet computer, a wearable device, or a combination of any of these devices.

For convenience of description, the above apparatus is divided into various units for separate description based on functions. Certainly, the functions of the units can be implemented in the same or a plurality of software and/or hardware during implementation of the embodiments of the present disclosure.

Those skilled in the art should understand that one or more embodiments of the present disclosure may be methods or computer program products. Therefore, one or more embodiments of the present disclosure may use the form of a complete hardware embodiment, a complete software embodiment, or a software and hardware combination embodiment. In addition, one or more embodiments of the present disclosure may use the form of a computer program product implemented on one or multiple computer-sensitive storage media (including, but not limited to, a magnetic disk memory, a compact disc read-only memory (CD-ROM), an optical memory and the like) including computer-sensitive program codes.

The present disclosure is described by referring to flowcharts and/or block diagrams of methods, devices (systems) and computer program products according to the embodiments of the present disclosure. It is worthwhile to note that computer program instructions can be used to implement each flow and/or each block in the flowcharts and/or the block diagrams and a combination of a flow and/or a block in the flowcharts and/or the block diagrams. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more flows in the flowcharts and/or in one or more blocks in the block diagrams.

These computer program instructions may also be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more flows in the flowcharts and/or in one or more blocks in the block diagrams.

These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more flows in the flowcharts and/or in one or more blocks in the block diagrams.

It is worthwhile to note that the terms “comprise”, “include”, or any other variation thereof are intended to cover a non-exclusive inclusion, so that a process, a method, an article, or a device that includes a list of elements includes those elements and further includes other elements not expressly listed or inherent to such a process, method, article, or device. Without more constraints, an element limited by “includes a . . . ” does not preclude the existence of additional identical elements in the process, method, product, or device that includes the element.

One or more embodiments of the present disclosure may be described in a general context of the computer-executable instructions, such as program modules, which are executed by a computer. Generally, the program modules include routines, programs, objects, components, data structures, classes, and the like that perform particular tasks or implement particular abstract data types. One or more embodiments of the present disclosure may alternatively be practiced in distributed computing environments where tasks are performed by remote processing devices that are connected through a communication network. In a distributed computing environment, the program modules may be located in local and remote computer storage media including storage devices.

The various embodiments in the present disclosure are all described progressively, and the same similar parts between the various embodiments can be referred to each other. Each embodiment focuses on differences from other embodiments. Particularly, the system embodiment is basically similar to the method embodiment, and therefore is described briefly. For related parts, refer to some of the descriptions in the method embodiment.

The above contents are only the embodiments of the present disclosure, but not intended to limit the present disclosure. Those skilled in the art can make various changes and modifications to the present disclosure. Any modifications, equivalent replacements, improvements and the like that are made without departing from the spirit and the principle of the present disclosure shall all fall within the scope of claims of the present disclosure.

I/We claim:

1. A memory leak detection method, comprising:
obtaining a memory leak detection instruction for a first application, and generating a running instruction for the first application based on the memory leak detection instruction randomly;
triggering the first application to run based on the running instruction, and obtaining running data of the first application;
obtaining a memory snapshot of the first application in response to the running data of the first application meeting a running data requirement; and
performing memory leak detection on a plurality of first specified classes of the first application based on the memory snapshot of the first application, the first specified classes comprising service-related classes in the first application.

2. The method according to claim 1, wherein before generating the running instruction for the first application based on the memory leak detection instruction randomly, the method further comprises:
obtaining a latest service code enabling rule of a first service based on the memory leak detection instruction, the first service being a service provided by the first application and having a plurality of versions of service codes, and the latest service code enabling rule being a latest rule of the first service for selecting and enabling a version of service code from the plurality of versions of service codes; and
configuring the first service based on the latest service code enabling rule, the configured first service being ran based on the latest service code enabling rule.

3. The method according to claim 2, wherein before obtaining the latest service code enabling rule of the first service based on the memory leak detection instruction, the method further comprises:
obtaining a memory leak detection installation package of the first application based on the memory leak detection instruction, the memory leak detection installation package of the first application being obtained by configuring a memory snapshot export interface for a user side installation package of the first application, and the memory snapshot export interface being used for exporting the memory snapshot of the first application; and
installing the first application by using the memory leak detection installation package of the first application.

4. The method according to claim 3, wherein obtaining the memory snapshot of the first application comprises:
sending a memory snapshot obtaining request to the first application through the memory snapshot export interface; and
obtaining, through the memory snapshot export interface, the memory snapshot returned by the first application based on the memory snapshot obtaining request.

5. The method according to claim 1, wherein obtaining the memory snapshot of the first application in response to the running data of the first application meeting the running data requirement comprises:
during running of the first application, obtaining the memory snapshot of the first application each time it is determined that the running data of the first application meets the running data requirement, until running duration of the first application reaches a first duration threshold.

6. The method according to claim 5, wherein obtaining the memory snapshot of the first application each time it is determined that the running data of the first application meets the running data requirement comprises:
obtaining the memory snapshot of the first application each time it is determined that a first memory occupied by the running of the first application is equal to or greater than a memory threshold; and
obtaining the memory snapshot of the first application at an interval of a second duration threshold.

7. The method according to claim 6, wherein before it is determined, for a first time, that the first memory occupied by the running of the first application is equal to or greater than the memory threshold, the method further comprises:
obtaining a total memory allocated to the first application by an operating system of the first application; and
using a product result of the total memory and a first proportion as the memory threshold.

8. The method according to claim 1, wherein performing the memory leak detection on the plurality of first specified classes of the first application based on the memory snapshot of the first application comprises:
for each first specified class of the first application, determining whether a memory leak occurs for the first specified class based on the memory snapshot of the first application; and
in response to the memory leak occurring for the first specified class, determining a memory leak cause of the first specified class based on the memory snapshot of the first application.

9. The method according to claim 8, wherein determining whether the memory leak occurs for the first specified class based on the memory snapshot of the first application comprises:
obtaining memory release information and memory occupancy data of the first specified class from the memory snapshot; and
in response to the memory release information indicating that a memory occupied by the first specified class has been released and the memory occupancy data indicating that the memory occupied by the first specified class is greater than zero, determining that the memory leak occurs for the first specified class.

10. The method according to claim 8, wherein determining the memory leak cause of the first specified class based on the memory snapshot of the first application comprises:
obtaining call link data of the first specified class from the memory snapshot, the call link data recording memory usage data of a related class which has a call relationship with the first specified class; and
determining the memory leak cause of the first specified class based on the call link data.

11. The method according to claim 10, wherein determining the memory leak cause of the first specified class based on the call link data comprises:
determining, based on the call link data and in the related class, a problem class causing the memory leak of the first specified class and problem memory usage data of the problem class; and
using the problem class and the problem memory usage data as the memory leak cause of the first specified class.

12. The method according to claim 8, wherein after determining the memory leak cause of the first specified class based on the memory snapshot of the first application, the method further comprises:
obtaining a memory leak size of the first specified class from the memory snapshot of the first application; and
generating a memory leak detection report of the first application based on the memory leak cause of the first specified class and the memory leak size of the first specified class.

13. An electronic device, comprising:
a processor; and
a memory configured to store computer-executable instructions which, when executed, configure the processor to:
obtain a memory leak detection instruction for a first application, and generate a running instruction for the first application based on the memory leak detection instruction randomly;
trigger the first application to run based on the running instruction, and obtain running data of the first application;
obtain a memory snapshot of the first application in response to the running data of the first application meeting a running data requirement; and
perform memory leak detection on a plurality of first specified classes of the first application based on the memory snapshot of the first application, the first specified classes comprising service-related classes in the first application.

14. The electronic device according to claim 13, wherein before the computer-executable instructions configuring the processor to generate the running instruction for the first application based on the memory leak detection instruction randomly, the computer-executable instructions further configure the processor to:
obtain a latest service code enabling rule of a first service based on the memory leak detection instruction, the first service being a service provided by the first application and having a plurality of versions of service codes, and the latest service code enabling rule being a latest rule of the first service for selecting and enabling a version of service code from the plurality of versions of service codes; and
configure the first service based on the latest service code enabling rule, the configured first service being ran based on the latest service code enabling rule.

15. The electronic device according to claim 14, wherein before the computer-executable instructions configuring the processor to obtain the latest service code enabling rule of the first service based on the memory leak detection instruction, the computer-executable instructions further configure the processor to:
obtain a memory leak detection installation package of the first application based on the memory leak detection instruction, the memory leak detection installation package of the first application being obtained by configuring a memory snapshot export interface for a user side installation package of the first application, and the memory snapshot export interface being used for exporting the memory snapshot of the first application; and
install the first application by using the memory leak detection installation package of the first application.

16. The electronic device according to claim 15, wherein the computer-executable instructions configuring the processor to obtain the memory snapshot of the first application comprises computer-executable instructions to configure the processor to:
send a memory snapshot obtaining request to the first application through the memory snapshot export interface; and
obtain, through the memory snapshot export interface, the memory snapshot returned by the first application based on the memory snapshot obtaining request.

17. The electronic device according to claim 13, wherein the computer-executable instructions configuring the processor to obtain the memory snapshot of the first application in response to the running data of the first application meeting the running data requirement comprise computer-executable instructions to configure the processor to:
during running of the first application, obtain the memory snapshot of the first application each time it is determined that the running data of the first application meets the running data requirement, until running duration of the first application reaches a first duration threshold.

18. The electronic device according to claim 17, wherein the computer-executable instructions configuring the processor to obtain the memory snapshot of the first application each time it is determined that the running data of the first application meets the running data requirement comprise computer-executable instructions to configure the processor to:
obtain the memory snapshot of the first application each time it is determined that a first memory occupied by the running of the first application is equal to or greater than a memory threshold; and
obtain the memory snapshot of the first application at an interval of a second duration threshold.

19. The electronic device according to claim 18, wherein before it is determined, for a first time, that the first memory occupied by the running of the first application is equal to or greater than the memory threshold, the computer-executable instructions further configure the processor to:
obtain a total memory allocated to the first application by an operating system of the first application; and
use a product result of the total memory and a first proportion as the memory threshold.

20. A non-transitory computer-readable storage medium for storing computer-executable instructions which, when executed by a processor, configure the processor to:
obtain a memory leak detection instruction for a first application, and generate a running instruction for the first application based on the memory leak detection instruction randomly;
trigger the first application to run based on the running instruction, and obtain running data of the first application;
obtain a memory snapshot of the first application in response to the running data of the first application meeting a running data requirement; and
perform memory leak detection on a plurality of first specified classes of the first application based on the memory snapshot of the first application, the first specified classes comprising service-related classes in the first application.
